(19) United States
(12) Patent Application Publication
(10) Pub. No.: US 2003/0225904 A1
(43) Pub. Date: Dec. 4, 2003

(54) Server load distribution apparatus, server load distribution program and server system

(75) Inventors: Shin-ichi Kanno, Kawasaki-shi (JP); Atsushi Sakai, Kawasaki-shi (JP)

Correspondence Address: Finnegan, Henderson, Farabow,, Garrett & Dunner, L.L.P., 1300 I Street, N.W., Washington, DC, 20005-3315, US

(73) Assignee: KABUSHIKI KAISHA TOSHIBA

(21) Appl. No.: 10/395,218

(22) Filed: Mar. 25, 2003

(30) Foreign Application Priority Data
Mar. 26, 2002 (JP) 2002-085113

(51) Int. Cl. G06F 15/16; G06F 15/173

(52) U.S. Cl. 709/232; 709/223

(57) ABSTRACT

A server load distribution apparatus provided between a client and servers including a first power supply and a control unit activating the first power supply depending on a command, comprises a unit for receiving a data request packet from one of the client computers, a unit for transferring the received data request packet to the one of the servers, a unit for counting the number of responses per unit of time, the responses being responses of the servers to the data request packet, a unit for determining an optimal number of the servers which are in operation based on the data request packet and the number of the responses, and instruct the transfer unit to transfer the data request packet to one of the servers, and a unit for supply a plurality of commands for activating the first power supply to the control units.

### CROSS-REFERENCE TO RELATED APPLICATIONS

This application is based upon and claims the benefit of priority from the prior Japanese Patent Application No. 2002-085113, filed Mar. 26, 2002, the entire contents of which are incorporated herein by reference.

### BACKGROUND OF THE INVENTION

1. Field of the Invention

The present invention relates to a load distribution apparatus, program and system for a server system including a plurality of servers, and more particularly to a load distribution apparatus, program and system for reducing the power consumption of a server system.

2. Description of the Related Art

Server systems are now being used widely in which a large number of unspecified or specified client computers (hereinafter referred to simply as “clients”) are connected to servers via a packet-exchange network, thereby enabling the clients to acquire data from the server when necessary. Most server systems include a plurality of servers. In this case, access to the server system by clients is distributed to and processed by each server.

In most conventional load distribution systems, access distribution is executed so that each server processes substantially to the same number of clients and substantially the same amount of communication traffic. These conventional load distribution systems are advantageous in that even if the servers do not individually have a great capability, access by a large number of clients is possible due to the number of servers involved.

However, it is necessary to activate all servers even if the rate of access from the clients is very low. Therefore if some of the servers in the server system have a great capability, they may consume more power, since they are kept running regardless of client access rate. Moreover, the occurrence of software problems (for example, operating software may become unstable) may increase because the servers are continuously in operation for a long period.

### BRIEF SUMMARY OF THE INVENTION

It is an object of the invention to reduce the power consumption in a server system including a plurality of servers.

According to a first aspect of the invention, there is provided a server load distribution apparatus provided between a plurality of servers and a plurality of client computers, each of the servers including a first power supply and a control unit activating the first power supply depending on a command, the server load distribution apparatus comprising: a receiving unit configured to receive a data request packet from one of the client computers; a transfer unit configured to transfer the data request packet to the one of the servers; a counting unit configured to count the number of responses per unit of time, the responses being responses of the servers to the data request packet; a first unit configured to determine an optimal combination of the servers which are in operation based on the data request packet and the number of the responses, and instruct the transfer unit to transfer the data request packet to one of the servers; and a second unit configured to supply a plurality of commands for activating the first power supply to the control units.

According to a second aspect of the invention, there is provided a server load distribution program product configured to be provided between a plurality of servers and a plurality of client computers, each of the servers including a first power supply and a control unit activating the first power supply depending on a command, the server load distribution program product configured to store program instructions for execution on a computer system enabling the computer system to perform: receiving a data request packet from one of the client computers; transferring the data request packet to the one of the servers; counting the number of responses per unit of time, the responses being responses of the servers to the data request packet; determining an optimal combination of the servers which are in operation based on the data request packet and the number of the responses, and issuing an instruction to transfer the data request packet to one of the servers; and supplying a plurality of commands for activating the first power supply to the control units.

According to a third aspect of the invention, there is provided a server system comprising: a plurality of servers including a control unit activating a first power supply depending on a command; and a server load distribution apparatus provided between the servers and a plurality of client computers, the server load distribution apparatus including: a receiving unit configured to receive a data request packet from one of the client computers; a transfer unit configured to transfer the data request packet; a counting unit configured to count the number of responses per unit of time, the responses being responses of the servers to the data request packet; a first unit configured to determine an optimal combination of the servers which are in operation based on the data request packet and the number of the responses, and instruct the transfer unit to transfer the data request packet to one of the servers; and a second unit configured to supply a plurality of commands for activating the first power supply to the control units.

### BRIEF DESCRIPTION OF THE SEVERAL VIEWS OF THE DRAWING

FIG. 1 is a schematic view illustrating a network system, to which a load distribution apparatus according to embodiments of the invention is used;

FIG. 2 is a block diagram illustrating a load distribution apparatus according to a first embodiment of the invention;

FIG. 3 is a block diagram illustrating a load distribution apparatus according to a second embodiment of the invention; and

FIG. 4A and FIG. 4B is a flowchart useful in explaining the operation of the load distribution apparatus.

### DETAILED DESCRIPTION OF THE INVENTION

Embodiments of the invention will be described with reference to the accompanying drawings.

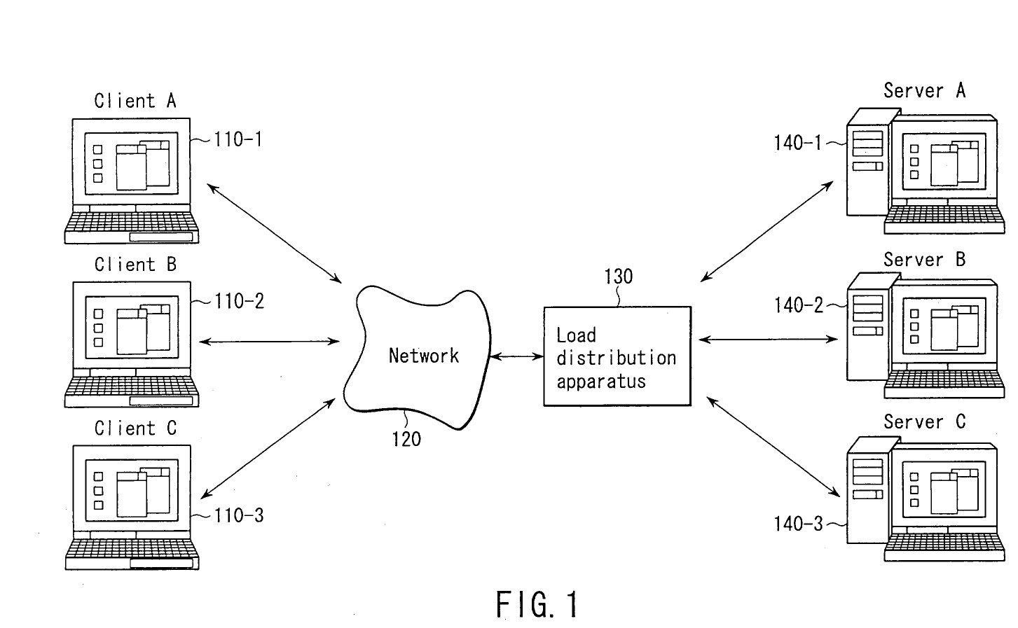

FIG. 1 is a schematic view illustrating a network system, to which a server load distribution apparatus (hereinafter referred to simply as a “load distribution apparatus”) according to embodiments of the invention is used. A server system including a plurality of servers 140 is connected to a network 120 via the load distribution apparatus 130. The communication of data packets between the server system and client computers 110 (hereinafter referred to simply as “clients”) connected to the network 120 is always carried out via the load distribution apparatus 130.

(First Embodiment)

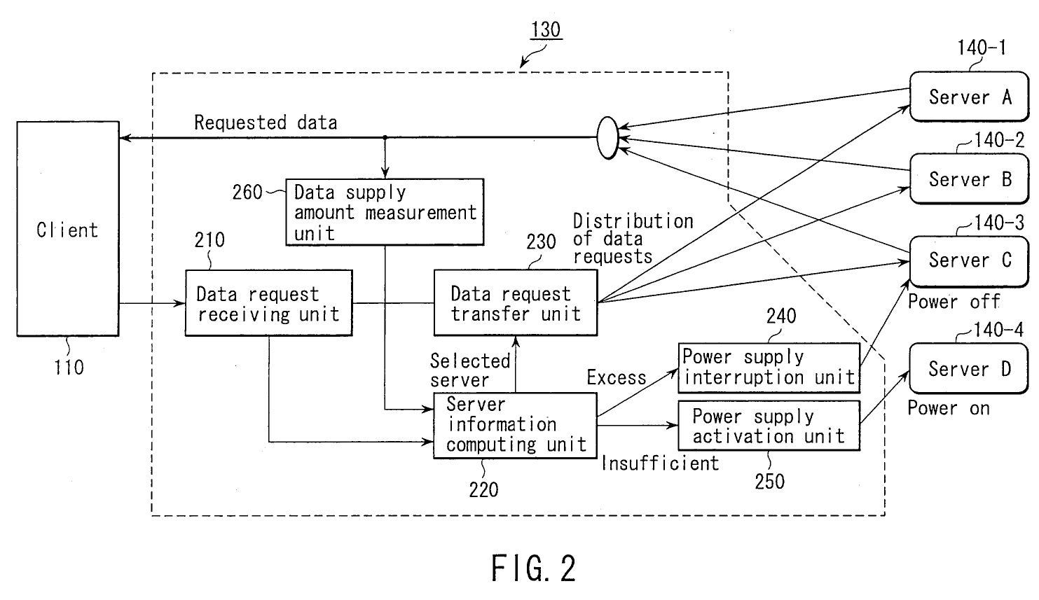

FIG. 2 is a block diagram illustrating a load distribution apparatus 130 according to a first embodiment of the invention. The load distribution apparatus 130 includes a data request receiving unit 210, server information computing unit 220, data request transfer unit 230, power supply interruption unit 240, power supply activation unit 250, and data supply amount measurement unit 260.

The data request receiving unit 210 receives a data request packet from at least one of clients 110. To receive the data request packet, it is necessary to establish a logical communication connection. The connection is established by three-way handshake system, if TCP/IP (Transmission Control Protocol/Internet Protocol) protocol is used. In the three-way handshake system, connection is established by (1) transmitting a connection request packet (SYN (SYNchronousness packet) from a connection requester (i.e. each client 110 in this embodiment) to a connection requested destination (i.e. the load distribution device 130 in this embodiment), (2) returning a connection request confirmation packet (SYN+ACK (Acknowledgement) packet) from the connection requested destination to the connection requester, and (3) further returning a confirmation response packet (ACK packet) from the connection requester to the connection requested destination. When connection is established, a data request packet (URL (Uniform Resource Locator) packet) sent from each client 110 is received by the data request receiving unit 210.

The received data request packet is sent to the server information computing unit 220 and data request transfer unit 230. On the basis of a data request amount, i.e., the number of data requests per unit of time, the server information computing unit 220 checks the amount of data presently requested to the server system, and also informs the data request transfer unit 230 of the server the data request packet should be sent to (selection of a destination server).

The data supply amount measurement unit 260 determines the number of occasions of response from the server system (140-1-140-4) to each client 110 within a predetermined period, i.e. the number of occasions of response of each server of the server system per unit of time, and informs the server information computing unit 220 of it.

If the server information computing unit 220 determines that the data amount requested to the server system is sufficiently small compared to the maximum amount of data that can be supplied by the server system, the power supply interruption unit 240 outputs an instruction to stop a server power supply control unit (not shown) for the presently operating server (server C in FIG. 2), thereby turning off the server C. This server power supply control unit is powered by a power supply different from the server power supply.

Conversely, if the amount of data requested to the server system is close to the maximum amount of data, the power supply activation unit 250 supplies a server power supply control unit for the presently stopped server (server D in FIG. 2) with an instruction to activate it, thereby turning on the power supply of the server D.

The server information computing unit 220, power supply interruption unit 240 and power supply activation unit 250 are linked, to reduce the entire server system processing capability so that the necessary minimum capability of processing the amount of data requested to the server system can be set. If some servers in the server system that correspond to the extra processing capability are stopped, the power consumption of the entire server system can be reduced by that of those servers.

(Second Embodiment)

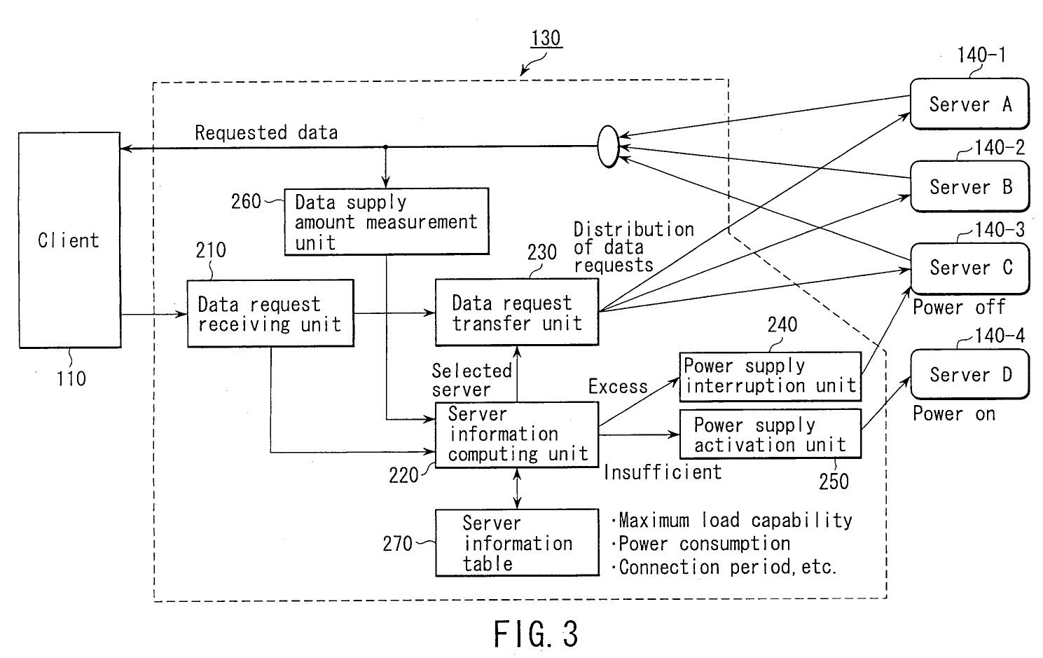

FIG. 3 is a block diagram illustrating a load distribution apparatus 130 according to a second embodiment of the invention. This apparatus differs from the apparatus 130 shown in FIG. 2 in that the former employs a server information table 270. The server information table 270 pre-stores information concerning the maximum load on each server, power consumption by each server, the continuous operation period of each server, etc. The other structures are similar to those of the first embodiment, therefore no description is given thereof.

The load distribution apparatus 130 according to the second embodiment can also reduce the power consumption of the server system, like the first embodiment. Further, referring to the server information table 270, the load on a server that has been in operation for a long period stored in the table 270 is reduced. If the load on a server that has been in operation for a long period is reduced, software operating in the server can be prevented from being greatly destabilized. Furthermore, the “mean time between failures (MTBF)” of components (e.g. a hard disk) that will show aging changes, such as abrasion, can be lengthened by temporarily interrupting the power supply for such a component or setting the power supply in a standby mode. In addition, if the CPU and the memory are set in a low power consumption mode, the amount of heat generated by each server can be reduced, thereby enabling its cooling fan to be stopped. Thus, the power consumption of the server system can be further reduced.

In the embodiment, the load distribution apparatus 130 may be modified such that the amount of data request packets per unit of time to be transferred to each operating server may be varied between different servers.

For example, the server information computing unit 220 may instruct the data request transfer unit 230 to transfer a larger amount of data request packets to a server that has consumed a smaller amount of power. Thus, the power consumption of the entire server system can be reduced by distributing a larger amount of load to a server that has consumed a smaller amount of power. Specifically, the server information computing unit 220 computes the amount of power consumed by each server with reference to the server information table 270, and determines the amount of data request packets to be transferred to each server per unit of time, on the basis of a rate determined in inverse proportion to the computed amount of power.

In addition, the operation of the server information computing unit 220 may be determined on the basis of continuous running periods stored in the server information table 270. In this case, a larger amount of data request packets are transferred per unit of time to a server that has continuously been in operation for a shorter period. In general, software that has been in operation for a long period on a server will easily become unstable. In this state, if heavy load is continuously applied, the server may become more unstable. In light of this, it is desirable that the load on a server that has continuously been in operation for a long period be lightened. This can eliminate the problem that a server having been in operation for a long period becomes unstable.

Also, a new server included in the server system can be in operation without stopping the presently operating servers. The load distribution apparatus 130 automatically distributes data requests from clients to all servers including the new server, in light of the remaining processing capability of the new server.

The power supply interruption unit 240 and the power supply activation unit 250 may be modified so that they set the servers in a low power consumption mode in which the servers are prevented from consuming power greater than a predetermined value, or the power consumption of the servers is reduced low. In this case, the server information computing unit 220 is set such that it fetches a server with a low frequency of use, and instructs the power supply interruption unit 240 and power supply activation unit 250 to set this server in the low power consumption mode. This prevents a server with a low frequency of use from consuming extra power, thereby reducing the power consumption of the entire server system.

To stop a server with a low frequency of use, or shift it to the low power consumption mode, the following can be performed. Where each server is rebooted at a predetermined point in time, using a timer for supplying power at the predetermined point in time, the power supply dedicated to each server is set not to be turned on to prevent reboot of the server. Specifically, the server information computing unit 220 prevents the timer corresponding to a server with a low frequency of use from being rebooted. This makes it unnecessary to set the server in the low power consumption mode, thereby preventing operating servers from becoming unstable.

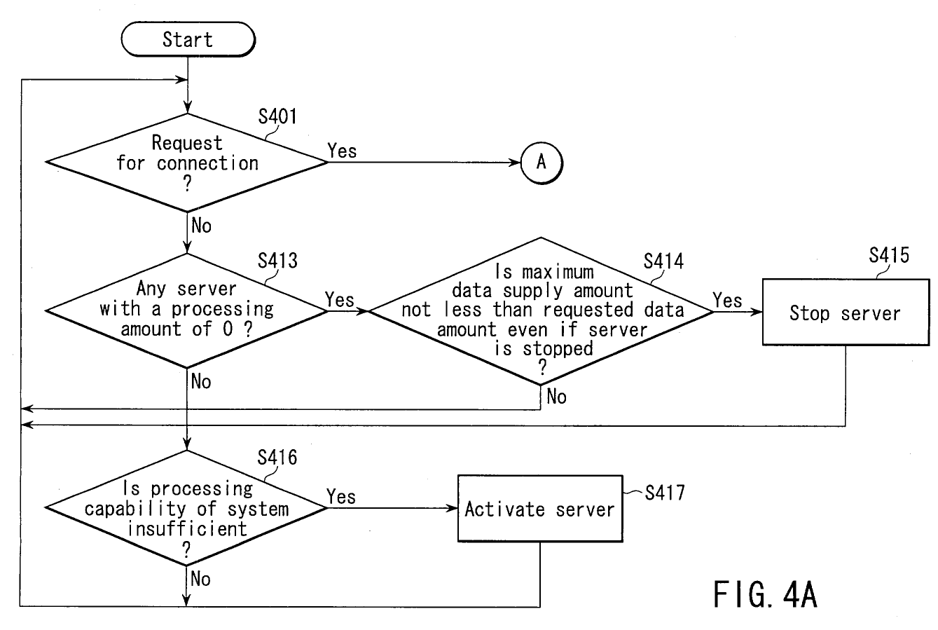

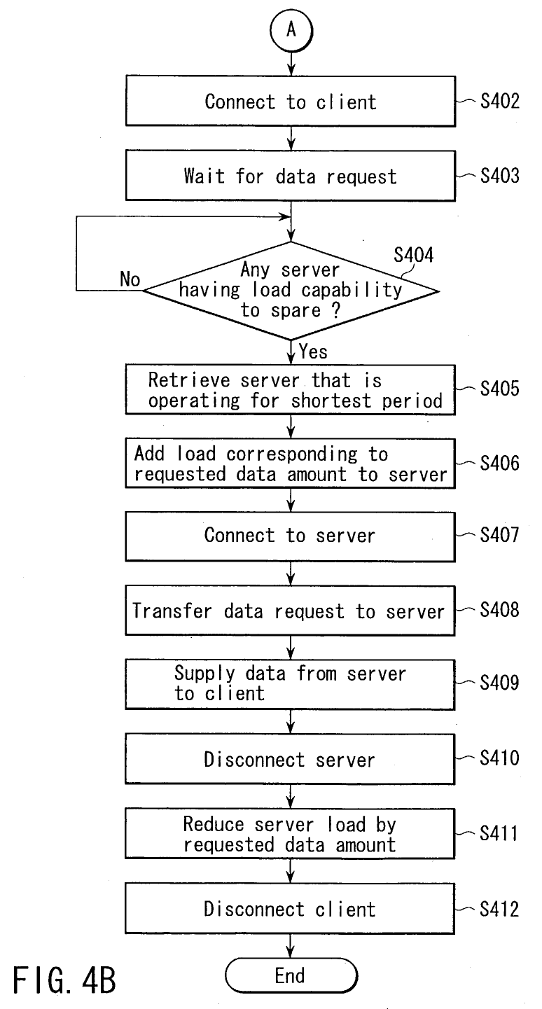

Referring to the flowchart of FIG. 4A and FIG. 4B, the process by the load distribution apparatus of each embodiment will be described.

Firstly, the data request receiving unit 210 determines whether or not there is a request for connection from a client (S401). If there is a request for connection, the load distribution apparatus 130 is connected to the client (S402), and waits for a data request packet from the client (S403).

Subsequently, the server information computing unit 220 determines, using the server information table 270, whether or not there are servers that have a load capability to spare (S404). If there are, the unit 220 retrieves the server that has been in operation for the shortest period of time, from the servers having a load capability to spare (S405). If the number of data requests that have not yet been processed in the server system is greater than the maximum number of data items (i.e., the maximum number of simultaneous response data items) that can be simultaneously supplied from the server that has been in operation for the shortest period, the unit 220 retrieves the server that has been in operation for the next shortest period. If the number of data requests from the client is smaller than the maximum number of response data items that can be simultaneously supplied from this server, this server is selected. Thereafter, the server information computing unit 220 increases the number of data requests that have not yet been processed, by the number of servers newly connected (S406), and the data request transfer unit 230 is connected to the destination server (S407), thereby transferring a data request packet to the server (S408). The server having received the data request packet supplies data corresponding to the data request to the client via the load distribution apparatus 130 (S409). The load distribution apparatus 130 is disconnected from the server (S410). After that, the server information computing unit 220 reduces, by the number of servers disconnected, the number of data requests stored and not yet processed (S411). Lastly, the load distribution apparatus 130 is disconnected from the client (S412).

On the other hand, if there is no request for connection at the step S401, the server information computing unit 220 determines whether or not there is a server with a processing amount of zero (S413). If such a server exists, the unit 220 determines whether or not the entire processing capability of the server system is sufficient for the present data request amount even if the server is stopped (S414). If it is sufficient, the unit 220 instructs the power supply interruption unit 240 to stop the server with the processing amount of zero (S415).

If such a server does not exist, it is determined whether or not the entire processing capability of the server system is insufficient (S416). If it is insufficient, and if there is a stopped server, the unit 220 instructs the power supply activation unit 250 to activate the server (S417). Activation of the server with the lowest power consumption enables effective power saving.

In the embodiment, the amount of data requested to the server system is compared with the maximum amount of data that can be presently supplied from the system. If the data request amount is close to the maximum data supply amount, it is determined that the server system may be overloaded, and the power supply activation unit 250 is made to activate a presently stopped server. Conversely, if the data request amount is reduced and there is a server with a processing amount of zero, it is determined whether or not the entire server system can perform data supply that corresponds to the data request amount, even if the server with the processing amount of zero is stopped. If it is determined that there is no problem in processing the data request if this server is stopped, the power supply interruption unit 240 is made to stop the server. This operation enables an optimal number of servers in the server system to be kept ON, the optimal number of servers corresponding to the amount of data requested by the clients. As a result, extra power consumption can be avoided.

(Modification)

If it is determined at the step S416 that the entire processing capability of the server system is sufficient, the step may be employed, at which it is determined whether or not the entire processing capability of the server system is sufficient even if a presently stopped server that consumed a small amount of power is used instead of a presently operating server that has consumed a large amount of power. If server switching is performed on the basis of the determination result at this step, the power consumption of the operating server system can be reduced. It is preferable that a server having consumed a large amount of power is switched to a server having consumed a small amount of power after the former has completely processed for a data request.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A server load distribution apparatus provided between a plurality of servers and a plurality of client computers, each of the servers including a first power supply and a control unit activating the first power supply depending on a command, the server load distribution apparatus comprising:
a receiving unit configured to receive a data request packet from one of the client computers;
a transfer unit configured to transfer the data request packet to the one of the servers;
a counting unit configured to count the number of responses per unit of time, the responses being responses of the servers to the data request packet;
a first unit configured to determine an optimal combination of the servers which are in operation based on the data request packet and the number of the responses, and instruct the transfer unit to transfer the data request packet to one of the servers; and
a second unit configured to supply a plurality of commands for activating the first power supply to the control units.

2. The server load distribution apparatus according to claim 1, further comprising a server information table storing at least one of a maximum load capacity, a power consumption and a continuous operation period of each of the servers, and wherein the first unit determines, based on the server information table, which server the transfer unit transfers the data request packet to.

3. The server load distribution apparatus according to claim 2, wherein the first unit sets the number of data request packets per unit of time transferred different between the servers.

4. The server load distribution apparatus according to claim 1, wherein the first unit detects one of the servers which has been in operation for a shortest period of time, and instructs the transfer unit to transfer the data request packet to the one of the servers which has been in operation for a shortest period of time.

5. The server load distribution apparatus according to claim 1, wherein the first unit determines an optimal number of the servers which are in operation, based on the data request packet and the number of the responses, and instructs the transfer unit to transfer the data request packet to one of the servers.

6. The server load distribution apparatus according to claim 5, wherein the second unit supplies, to the control unit included in each of the servers, one of a first command for stopping the first power supply of each of the servers and a second command for activating the first power supply of each of the servers, based on the optimal combination.

7. The server load distribution apparatus according to claim 1, wherein the second unit supplies, to the control unit included in each of the servers, one of a first command for stopping the first power supply of each of the servers and a second command for activating the first power supply of each of the servers, based on the optimal combination.

8. The server load distribution apparatus according to claim 1, wherein the second unit supplies, to the control unit included in each of the servers, one of a first command for stopping the first power supply of each of the servers and a second command for activating the first power supply of each of the servers in a mode which sets at least an upper limit of a power consumption due to each of the servers, based on the optimal combination.

9. A server load distribution program product configured to be provided between a plurality of servers and a plurality of client computers, each of the servers including a first power supply and a control unit activating the first power supply depending on a command, the server load distribution program product configured to store program instructions for execution on a computer system enabling the computer system to perform:
receiving a data request packet from one of the client computers;
transferring the data request packet to the one of the servers;
counting the number of responses per unit of time, the responses being responses of the servers to the data request packet;
determining an optimal combination of the servers which are in operation based on the data request packet and the number of the responses, and issuing an instruction to transfer the data request packet to one of the servers; and
supplying a plurality of commands for activating the first power supply to the control units.

10. The server load distribution program product according to claim 9, wherein determining the optimal combination determines which server the data request packet is transferred to, based on a server information table storing at least one of a maximum load capacity, a power consumption and a continuous operation period of each of the servers.

11. The server load distribution program product according to claim 9, wherein determining the optimal combination sets the number of data request packets per unit of time transferred different between the servers.

12. The server load distribution program product according to claim 9, wherein determining the optimal combination detects one of the servers which has been in operation for a shortest period of time, and issues an instruction to transfer the data request packet to the one of the servers which has been in operation for a shortest period of time.

13. The server load distribution program product according to claim 9, wherein determining the optimal combination determines an optimal number of the servers which are in operation, based on the data request packet and the number of the responses, and issues an instruction to transfer the data request packet to one of the servers.

14. The server load distribution program product according to claim 9, wherein supplying the commands supplies, to the control unit included in each of the servers, one of a first command for stopping the first power supply of each of the servers and a second command for activating the first power supply of each of the servers, based on the optimal combination.

15. The server load distribution program product according to claim 9, wherein supplying the commands supplies, to the control unit included in each of the servers, one of a first command for stopping the first power supply of each of the servers and a second command for activating the first power supply of each of the servers in a mode which sets at least an upper limit of a power consumption due to each of the servers, based on the optimal combination.

16. A server system comprising:
a plurality of servers including a control unit activating a first power supply depending on a command; and
a server load distribution apparatus provided between the servers and a plurality of client computers, the server load distribution apparatus including:
a receiving unit configured to receive a data request packet from one of the client computers;
a transfer unit configured to transfer the data request packet;
a counting unit configured to count the number of responses per unit of time, the responses being responses of the servers to the data request packet;
a first unit configured to determine an optimal combination of the servers which are in operation based on the data request packet and the number of the responses, and instruct the transfer unit to transfer the data request packet to one of the servers; and
a second unit configured to supply a plurality of commands for activating the first power supply to the control units.

17. The server system according to claim 16, further comprising a server information table storing at least one of a maximum load capacity, a power consumption and a continuous operation period of each of the servers, and wherein the first unit determines, based on the server information table, which server the transfer unit transfers the data request packet to.

18. The server system according to claim 17, wherein the first unit sets the number of data request packets per unit of time transferred different between the servers.

19. The server system according to claim 16, wherein the first unit detects one of the servers which has been in operation for a shortest period of time, and instructs the transfer unit to transfer the data request packet to one of the servers which has been in operation for a shortest period of time.

20. The server system according to claim 16, wherein the second unit supplies, to the control unit included in each of the servers, one of a first command for stopping the first power supply of each of the servers and a second command for activating the first power supply of the servers, based on the optimal combination.

21. The server system according to claim 16, wherein the second unit supplies, to the control unit included in each of the servers, one of a first command for stopping the first power supply of each of the servers and a second command for activating the first power supply of each of the servers in a mode which sets at least an upper limit of a power consumption due to each of the servers, based on the optimal combination.
